(19) United States
(12) Patent Application Publication
(10) Pub. No.: US 2013/0283995 A1
(43) Pub. Date: Oct. 31, 2013

(54) Waveguide Apparatus for Conducting Sound Energy

(71) Applicants: Steve Lynn Gorman, Maryville, TN (US); Johnathan Charles Gorman, Maryville, TN (US)

(72) Inventors: Steve Lynn Gorman, Maryville, TN (US); Johnathan Charles Gorman, Maryville, TN (US)

(21) Appl. No.: 13/928,048

(22) Filed: Jun. 26, 2013

Related U.S. Application Data
(63) Continuation-in-part of application No. 13/112,408, filed on May 20, 2011.

(51) Int. Cl. G10D 3/02

(52) U.S. Cl. CPC G10D 3/02
USPC 84/294

(57) ABSTRACT

An apparatus to conduct sound waves through a musical instrument having at least one string mounted on a bridge to vibrate above a first surface of the musical instrument and at least one electrical pickup mounted to the first surface to receive sound waves from the at least one string, the apparatus including: a conductive member fixedly mounted to the musical instrument and spaced apart from the first surface to conduct sound energy from the at least one string to the at least one electrical pickup; and at least one bridge connector to conduct sound energy from the at least one string from the bridge to the conductive member.

### CROSS-REFERENCE TO RELATED APPLICATIONS

This is a Continuation-in-Part Patent Application that claims the benefit of U.S. Provisional Application 61/379,763, filed Sep. 9, 2010 and U.S. Utility patent application Ser. 13/112,408, filed May 20, 2011, the entire contents of which are hereby incorporated herein.

### STATEMENT REGARDING FEDERALLY SPONSORED RESEARCH OR DEVELOPMENT

Not Applicable

### BACKGROUND

1. Field of Invention

The present invention relates generally to a waveguide apparatus for string instruments for the purpose of conducting sound energy from the vibrating strings of the instrument through a conductive member.

More particularly, the present invention relates to an apparatus for string instruments that functions as a waveguide for the purpose of maintaining proper phase alignment between the sound waves produced by the vibrating strings of the instrument through the conductive member and continuing to the pickup(s). Maintaining phase alignment integrity between the sound waves and the apparatus enhances the tonal integrity of the electric string instrument.

2. Description of the Related Art

In conducting sound energy from vibrating strings to an electrical pickup or plurality of pickups, sound energy typically may be distorted in three ways. First, sound energy may be dampened or lost when passing through relatively soft materials with radically different acoustic properties such as wood, plastic, or springs. Second, sound energy may be reflected as they it crosses from metal to different materials such as wood, plastic or a plurality of springs thereby setting up an unrealistic resonance. Third, sound energy may be modulated due to the electric pickup(s) being mounted on springs, plastic or wood and allowed to vibrate out of phase with the vibrating string.

Electric string instruments, such as electric guitars for one example, typically utilize metal strings. The body of the instrument is often made of wood or plastic of some type. As the sound energy passes from the vibrating string into the wood or other nonmetallic material, the sound waves produced by the metal strings are altered to some degree, due to the speed of sound differential between wood and other nonmetallic material. The portion of the sound wave(s) that is reflected as it passes through the wood or other non-metal material undergoes a phase shift. The amount of the phase shift directly correlates with the speed of sound differential of the wood or other non-metal material.

In an effort to maintain sound wave phase integrity, electric string instruments have been constructed of all-metal materials. Often, these all-metal instruments have been crafted using metal of same or similar density to the strings used to make the sound waves of the instrument. These all-metal instruments, however, produced a sound unfavored by the human ear. The majority of human listeners, whether performer or audience, tend to prefer some reflection of the metal string(s) sound wave by allowing the sound wave to come in contact with either wood or some non-metal material. Modest reflection allows sufficient, minor phase shift to the sound waves so that the human ear hears the sound wave as “warmer” or more mellow in tone than the sound waves produced on an all-metal instrument.

The issue, then, becomes balancing transmission of the sound waves produced by the metal string or strings to the electrical pickup or plurality of pickups in the electric string instrument, while allowing some modest reflection of the sound waves into the wood or non-metal body of the instrument. Modest reflection of the sound waves is inherently achieved if one constructs the instrument body from wood or other nonmetallic material. Thus the need is to maintain as much sound wave phase integrity as possible between the metal string and the electrical pickup or plurality of pickups within the electric string instrument. In order to maintain sound wave phase integrity, one would create a path of uniform density and elastic modulus, described herein as a waveguide through which the sound wave could travel, unimpeded, between the originating metal string and the electrical pickup or plurality of pickups.

### BRIEF SUMMARY

The “Waveguide Apparatus for Conducting Sound Energy” is for an electric string instrument, such as, but not limited to, a member of the guitar, bass, mandolin or violin family. The apparatus comprises a conductive member and at least one connector, to conduct sound waves in-phase from the vibrating string(s) of the musical instrument through the at least one connector to the resonant apparatus. The apparatus provides for proper phase alignment between the vibrating string or strings and the apparatus, thus enhancing clarity of tone within the sound.

An embodiment includes at least one vibrating string, at least one connector, and at least one acoustically conductive member. The components are fixedly connected to one another to ensure proper transfer of sound energy. The conductive member is fixedly attached to the musical instrument in order to ensure proper acoustic conductivity of sound waves while simultaneously providing structural support. In some embodiments, in-phase conduction of the sound wave is continued, through the conductive member by means of a second connector, directly to the electrical pickup or plurality of pickups. In some embodiments, at least one adjustable connector is provided for each pickup. In some embodiments, one set of adjustable connectors is in compression while another set is in tension. This allows for precise adjustment of the pickup height while ensuring proper sound propagation into the pickup. Adjustable connectors also provide a means for the user of the instrument to determine whether to create a complete, in-phase sound wave from the vibrating string(s) to the electrical pickup(s), or, alternatively, by adjusting the adjustable connector(s) between the conductive member and the electrical pickup(s), the user may stop the in-phase conduction of the sound wave at the resonant apparatus. Thus the apparatus provides for flexibility of sound wave conduction.

### BRIEF DESCRIPTION OF THE DRAWINGS

The above-mentioned and additional features of the apparatus will become more clearly understood from the following detailed description of the apparatus read together with the drawings in which:

FIG. 1 is a diagram illustrating a top view of a typical electric string instrument, showing six strings crossing over two electrical pickups and attaching at the bridge;

FIG. 2 is a diagram illustrating a rear view of an embodiment showing the apparatus attached to a typical electric string instrument;

FIG. 3 is a diagram illustrating a cross-section of an embodiment of the apparatus taken along line 3-3 of FIG. 2;

FIG. 4 is a diagram illustrating an alternative cross-section of an embodiment of the apparatus taken along line 3-3 of FIG. 2; and

FIG. 5 is a diagram illustrating the alignment of strings and pickups in a typical string musical instrument.

### DETAILED DESCRIPTION

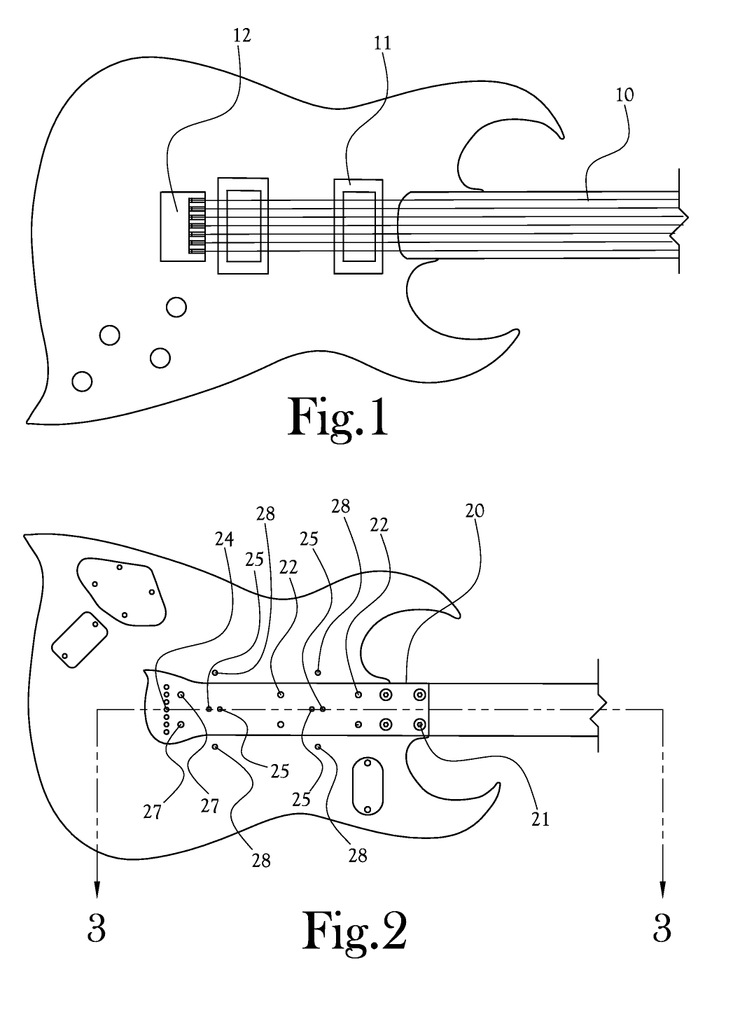

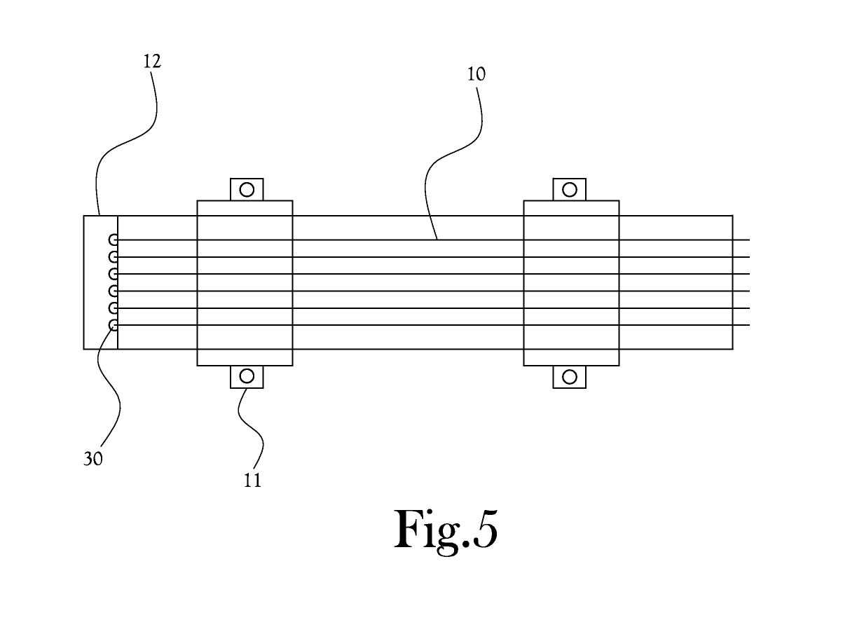

The present apparatus, in some of its embodiments, may be utilized on many string instruments, such as, but not limited to, an electric guitar, as illustrated in FIG. 1. More than one string 10 is shown, however, only but at least one string 10 is required for the apparatus to function. The string 10 is strung so as to be suspended over at least one electrical pickup 11. In some embodiments, string 10 is attached to the bridge 12 of the guitar and strung to the tuning keys (not shown) on the head (not shown) of the guitar. FIG. 5 is provided to illustrate how string 10 is typically oriented over electrical pickup 11, with string 10 terminating at bridge 12 at points of attachment 30 within or upon bridge 12.

As illustrated in FIG. 2, the conductive member or acoustically conductive member 20 is fixedly attached to the string instrument at various points of attachment 21 and 22. In an embodiment, point of attachment 21 attaches the conductive member 20 to the body and/or neck of the instrument. In an embodiment, point of attachment 22 attaches the conductive member to the body of the instrument. In some embodiments, points of attachment 21 and 22 are holes drilled in the conductive member 20 so that a means of fixedly attaching the conductive member 20 may be inserted at points of attachment 21 and 22. In some embodiments, points of attachment 21 would include both the body and neck of the instrument, hence points of attachment 21 would be larger to accommodate a stronger means of fixedly attaching the conductive member 20 to the body and neck of the instrument.

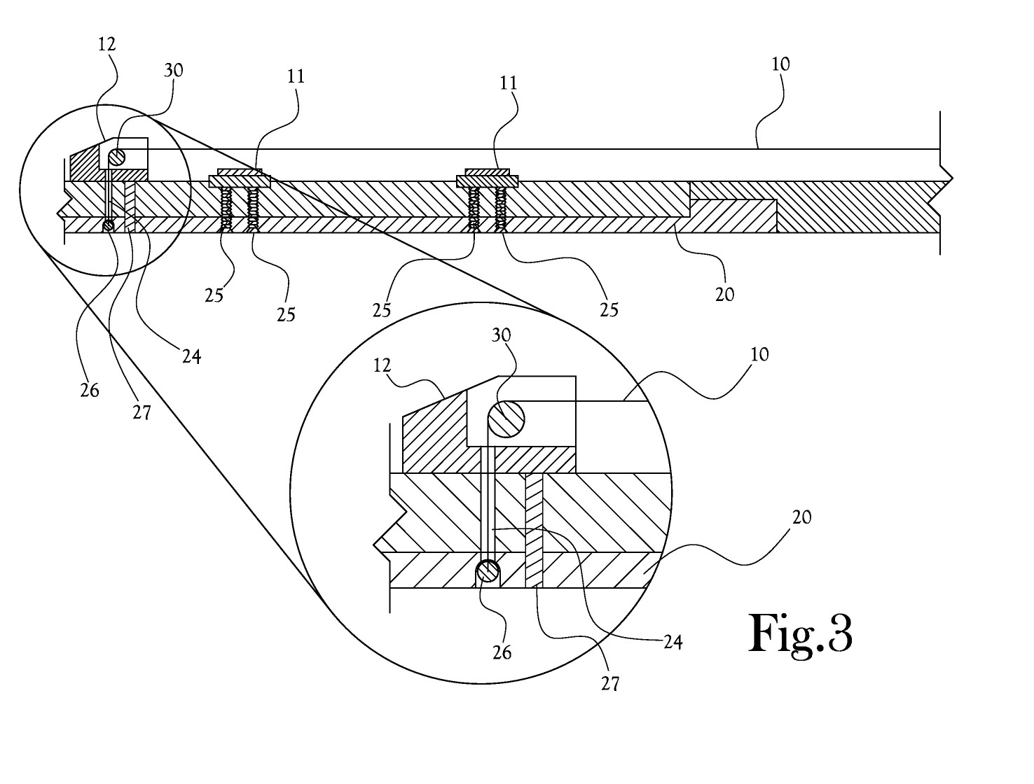

FIG. 3 illustrates an embodiment of an instrument apparatus wherein a string 10 is mounted on a bridge 12 to vibrate above a top surface of a musical instrument. The vibration of the string is detected by pickups 11. The string is supported at a termination point 30 and is strung through a lumen bored in the bridge and instrument body to a conductive member 20. A terminator 26 on the string is secured in a recess in the conductive member to keep tension on the string. A conductive bridge connector 27 connects the bridge to the conductive member through which sound energy is conducted.

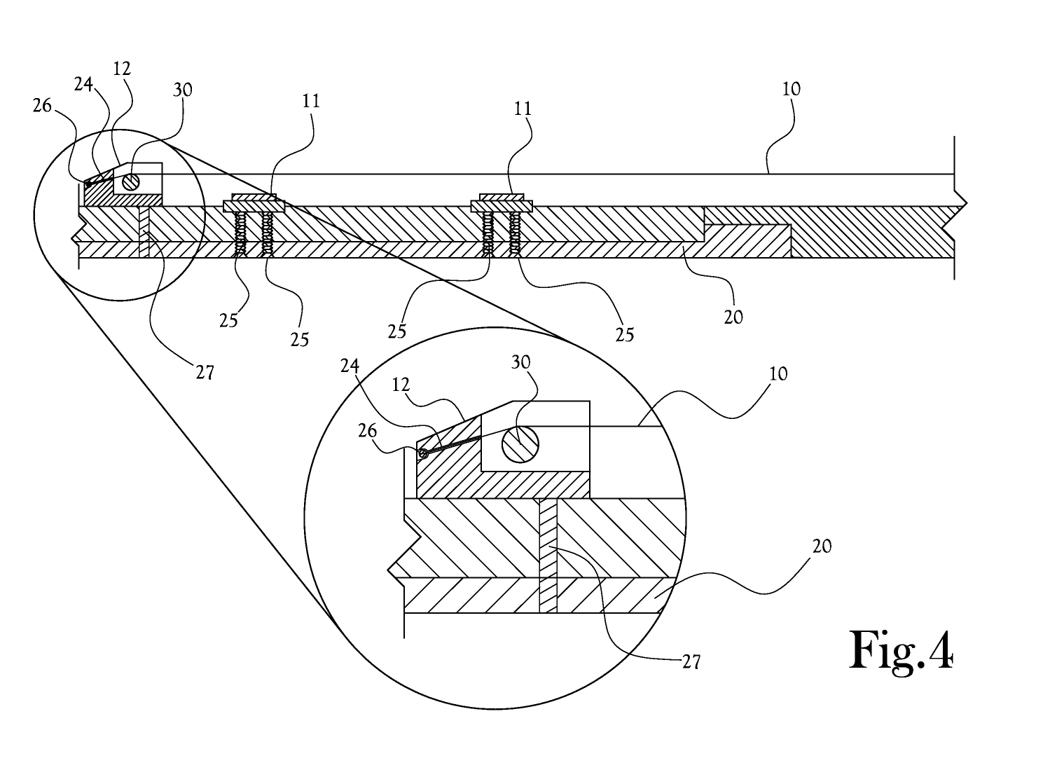

FIG. 4 illustrates an embodiment of an instrument apparatus wherein a string 10 is mounted on a bridge 12 to vibrate above a top surface of a musical instrument. The vibration of the string is detected by pickups 11. The string is supported at a termination point 30 and is strung through a lumen in the bridge to the rear or back of the bridge. A terminator 26 on the string is secured in a recess in the back of the bridge to keep tension on the string. A bridge connector 27 connects the bridge to the conductive member through which sound energy is conducted.

Thus in some embodiments, the point of attachment of string 10 may be the bridge 12, as illustrated in FIG. 4, where point of attachment 26 contains a terminal end of string 10 and point of attachment 26 connects the terminal end of string 10 to the bridge 12 as illustrated in FIG. 4. In other embodiments, string 10 may attach at conductive member 20 where conductive member 20 is bored in the center so as to allow string 10 to pass through to point of attachment 26 and attach to conductive member 20, as illustrated in FIG. 3.

Irrespective of either type of attachment, effective functionality will occur for these components of the apparatus so long as string 10 is allowed to conduct sound energy to conductive member 20 by means of bridge connector 27.

To effectively conduct a sound wave between the vibrating string 10 and the electrical pickup 11, string 10 vibrates and transmits the sound energy through bridge connector 27 to the conductive member 20 and the conductive member 20 continues conducting the sound energy to pickup connector 25 where the sound energy is carried along or conducted through pickup connector 25 to the electrical pickup 11. In an embodiment the conductive member 20 is fixedly attached to the musical instrument to avoid unwanted vibrations during conduction of the sound energy from string 10 through conductive member 20 to electrical pickup 11. In some embodiments, pickup connector 25 is adjustable, to provide for optimal placement of electrical pickup 11 relative to string 10. Utilizing an adjustable connector 25 also enables the user of the instrument to determine the terminal point of in-phase sound energy conduction, either within the conductive member 20, or, if the at least one pickup connector 25 is included, the in-phase sound energy conduction will terminate in the electrical pickup 11.

In an embodiment, string 10, bridge 12, bridge connector 27 conductive member 20 and optional pickup connector 25 are all constructed out of materials with acoustically similar properties to the at least one string, to provide optimal in-phase transfer of a sound energy from string 10 to electrical pickup 11. “Acoustically similar” herein refers to the speed of sound as a function of density and elastic modulus. In some embodiments, string 10, bridge 12, bridge connector 27, conductive member 20 and optional pickup connector 25 are all constructed out of a metal. In some embodiments, string 10, bridge 12, bridge connector 27, conductive member 20 and optional pickup connector 25 are all constructed out of a like metal, for example, steel.

As an example, such like or acoustically similar material might be, but is not limited to, any material from which a musical instrument string 10 is currently manufactured, such as, for one example, steel. If the string 10, string connector 26, pickup connector 25, and conductive member or element 20 are all made of steel, as one example, the acoustic similarity of these like materials enables sound energy, generated by the manipulation of the string 10 by the player of the musical instrument, to travel in relative consonance from string 10 through bridge connector 27 to conductive member 20, and, optionally, through conductive member 20 to pickup connector 25 and through pickup connector 25 to electrical pickup 11. This path of travel through acoustically similar materials creates an unbroken and unfettered line between the string 10 and the conductive member 20, and, in some embodiments, through the conductive member 20 through the electrical pickup 11, thus minimizing harmonic distortion, enhancing the purity of the sound wave and achieving greater clarity of tone, because the sound wave can travel in-phase.

In some embodiments, optional pickup connector 25 is not included. In other embodiments, optional pickup connector 25 is a means to fixedly connect conductive member 20 to electrical pickup 11. In other embodiments, optional pickup connector 25 is adjustable, to provide flexibility with respect to at least two aspects. First, for user control in precisely adjusting the electrical pickup 11, and, second, for user control over how much, if any, in-phase sound wave conduction occurs between conductive member 20 and electrical pickup 11. Such adjustment and control allows a player artistic discretion in the sound of the instrument.

In an embodiment there is a continuous metallic path between the vibrating string and the pickup which allows sound energy to travel to the pickup in-phase. This reduces harmonic distortion and causes the guitar to have a “clean” or “clear” sound.

In an embodiment the apparatus causes some of the sound energy that might have been reflected out of phase to be conducted through the metallic components, which allows the at least one string to sustain longer which is a desirable characteristic for players.

In an embodiment, the instrument has a wooden body that permits relatively little sound energy crossing the boundary between the bridge and the body of the instrument. The wood however, still serves to color the sound. The physics behind this coloration is complex involving reflections and refractions. The human ear may however, prefer to receive sounds colored by the resonate characteristics of wood.

In an embodiment, the instrument may be built entirely out of metal.

In an embodiment, the apparatus conducts sound energy, both longitudinal (compressional waves) and laterally (transverse waves) from their source, the vibrating string, to the pickups, in phase.

While the present apparatus has been illustrated by description of some embodiments, and while the illustrative embodiments have been described in detail, it is not the intention of the applicant to restrict or in any way limit the scope of the appended claims to such detail. Additional modifications will readily appear to those skilled in the art. The apparatus in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus to conduct sound waves through a musical instrument having at least one string mounted on a bridge to vibrate above a first surface of the musical instrument and at least one electrical pickup mounted to the first surface to receive sound waves from the at least one string, the apparatus comprising:
a conductive member fixedly mounted to the musical instrument to conduct sound energy from the at least one string to the at least one electrical pickup; and
at least one bridge connector to conduct sound energy from the at least one string from the bridge to the conductive member.

2. The apparatus according to claim 1, such that the conductive member is fixedly mounted to the musical instrument.

3. The apparatus according to claim 1, further comprising at least one pickup connector to conduct sound energy from the conductive member to the at least one electrical pickup.

4. The apparatus according to claim 1, wherein the conductive member and/or the at least one bridge connector is comprised of material that has a similar speed of sound as a function of density and elastic modulus as the bridge.

5. The apparatus according to claim 1, wherein the conductive member is comprised of acoustically similar material as the at least one string.

6. The apparatus according to claim 1, wherein the at least one bridge connector is comprised of acoustically similar material as the bridge.

7. The apparatus according to claim 1, wherein the at least one bridge connector is comprised of acoustically similar material as the at least one string.

8. The apparatus according to claim 1, wherein the conductive member is comprised of acoustically similar material as the at least one bridge connector.

9. The apparatus according to claim 1, wherein the conductive member is comprised of a metal.

10. The apparatus according to claim 1, wherein the at least one bridge connector is comprised of a metal.

11. The apparatus according to claim 1, wherein the conductive member and the at least one bridge connector are comprised of steel.

12. The apparatus according to claim 1, wherein the conductive member is comprised of steel.

13. The apparatus according to claim 1, wherein the at least one bridge connector is comprised of steel.

14. The apparatus according to claim 1, wherein the conductive member and/or the at least one bridge connector are comprised of steel.

15. The apparatus according to claim 3, wherein the at least one pickup connector is adjustable.

16. An apparatus to conduct sound waves through a musical instrument having at least one string mounted on a bridge to vibrate above a first surface of the musical instrument and at least one electrical pickup mounted to the first surface to receive sound waves from the at least one string, the apparatus comprising:
a conductive element fixedly mounted to the musical instrument to conduct sound energy; and
at least one bridge connector to conduct sound energy from the at least one string through the bridge to the conductive element; and,
at least one pickup connector to conduct sound energy from the conductive element to the at least one electrical pickup.

17. The apparatus according to claim 16, wherein the conductive member is fixedly mounted to the musical instrument.

18. The apparatus according to claim 16, wherein the following are comprised of acoustically similar material: the at least one string; the bridge; the at least one bridge connector; the conductive member; and the at least one pickup connector.

19. The apparatus according to claim 1, wherein the following are comprised of acoustically similar material: the at least one string; the at least one bridge connector; the conductive member and the at least one pickup connector.

20. The apparatus according to claim 1, wherein the at least one bridge connector is comprised of acoustically similar material as the at least one string.

21. The apparatus according to claim 1, wherein the at least one bridge connector is comprised of a metal.

22. The apparatus according to claim 1, wherein the at least one bridge connector is comprised of steel.

23. The apparatus according to claim 1, wherein the at least one bridge connector is comprised of acoustically similar material as the conductive member.
